(19) United States
(12) Patent Application Publication
(10) Pub. No.: US 2026/0084456 A1
(43) Pub. Date: Mar. 26, 2026

(54) BOOKBINDING MACHINE WITH A DEVICE FOR FEEDING BOOK BLOCKS UPWARDS FROM AN INCLINED POSITION

(71) Applicant: MECCANOTECNICA S.P.A., GAZZANIGA (IT)

(72) Inventors: Thomas Friese, GroBposna (DE); Frank Sommerer, GroBposna (DE)

(73) Assignee: MECCANOTECNICA S.P.A., GAZZANIGA (IT)

(21) Appl. No.: 19/110,956

(22) PCT Filed: Sep. 15, 2023
(86) PCT No.: PCT/EP2023/075471

§ 371 Date: Mar. 12, 2025

(30) Foreign Application Priority Data
Sep. 16, 2022 (IT) 102022000019059

(51) Int. Cl. B42C 19/08

(52) U.S. Cl. CPC B42C 19/08

(57) ABSTRACT

A bookbinding machine (100) for processing book blocks (210) is proposed. The bookbinding machine (100) comprises a feeding device (200) for feeding the book blocks (210) to a loading station (105a). The feeding device (200) comprises an inclined support (205) for supporting a front or a rear of each book block (210) in a staging position below the loading station (105a). A raising system (225) raises the book block (210) from the staging position to a loading position within the loading station (105a); this comprises moving the book block (210) transversally to its spine (210s) to put the book block (210) in vertical position. A feeding device (200) for use in the bookbinding machine (100) and a bookbinding plant comprising one or more of these bookbinding machines (100) are also proposed. Moreover, a corresponding method for feeding a bookbinding machine (100), a computer program and a computer program product for implementing the method are proposed.

### TECHNICAL FIELD

The present disclosure relates to the bookbinding field. More specifically, this disclosure relates to the feeding of book blocks in bookbinding machines.

### BACKGROUND ART

The background of the present disclosure is hereinafter introduced with the discussion of techniques relating to its context. However, even when this discussion refers to documents, acts, artifacts and the like, it does not suggest or represent that the discussed techniques are part of the prior art or are common general knowledge in the field relevant to the present disclosure.

Bookbinding machines of different types are commonly used in bookbinding plants to produce books at industrial level. For example, (bookbinding) perfect-binding machines are used to apply soft covers and/or fastening linings to corresponding book blocks. Particularly, perfect-binding machines of small size have become very popular for the production of books being printed digitally. In fact, these perfect-binding machines allow producing books of different formats (i.e., width, height and/or thickness) in succession. Therefore, the books may be produced on-demand (such as in case of individual photo books, self-published books, small series and so on), thereby dispensing with warehousing thereof.

In general terms, each perfect-binding machine has several processing stations that are used to perform different operations on the book blocks. For this purpose, a transport system transports the book blocks in succession across the processing stations. Typically, the transport system drives clamps transporting the book blocks individually; particularly, each clamp comprises two jaws that clamp the corresponding book block vertically close to its spine.

The book blocks to be processed are typically fed manually to the perfect-binding machine by an operator thereof. For this purpose, the operator picks-up each book block and inserts it into a clamp being stopped and opened in a corresponding loading (processing) station; the book block is inserted into the clamp vertically from above, with its spine facing downwards that rests on a support plate arranged below the clamp. Alternatively, the operator inserts each book block (again vertically with its spine facing downwards) into a feeding channel that feeds the book blocks (moving along their spines) to the loading station. For example, the feeding channel transports each book block (extending vertically) horizontally below the loading station, wherein it is raised vertically into the clamp being stopped and opened therein. Alternatively, each book block (extending vertically) is raised obliquely into the clamp that passes (being opened) through the loading station without stopping. For example, for this purpose EP-A-1688269 describes an inclined ramp on which the book blocks rest with their spine.

However, the manual feeding of the book blocks is physically demanding, monotonous, skill dependent and prone to errors, especially in case of large and/or heavy book blocks. Moreover, this operation is relatively slow, so that it creates a bottleneck for operation of the perfect-binding machine that significantly limits its yield. This is further exacerbated by security measures that are normally implemented to reduce the risk of injuries for the operator (for example, light curtains preventing access to the clamp until it has been completely opened).

Feeding devices for feeding the book blocks automatically to the perfect-binding machine may also be used. Each feeding device receives the book blocks arranged horizontally on a conveyor and feeds them in succession to the clamp.

For example, the feeding device may cause each book block to fall into the clamp or the feeding channel, thereby turning from horizontally to vertically. However, the feeding device is arranged at the same position that would be used to feed the book blocks manually. Therefore, it is not possible to feed some book blocks manually (for example, to cope with contingent needs), unless a time-consuming changeover is performed.

As a further example, the feeding device may comprise a manipulator with a gripper than takes each book block laterally, turns the book block vertically and inserts the book block from above into the clamp. However, the manipulator is relatively complex and expensive. The sequence of movements to be applied to the book blocks are relatively slow (especially in case of large and/or heavy book blocks), so that the obtained increase of yield of the perfect-binding machine is negligible in most practical situations. Moreover, the book blocks should arrive on the conveyor with their front facing downwards. This is required for allowing the gripper to turn each book block and load it into the clamp with its front facing outwards the perfect-binding machine, in order to have the (processed) book blocks being delivered by the perfect-binding machine with their front (showing titles of the corresponding books) facing upwards for allowing visual inspection thereof. However, this prevents a visual inspection of the book blocks that are provided to the perfect-binding machine and may cause a damage/contamination of the front of the book blocks by the conveyor.

As another further example, the feeding device may comprise a turning channel with a wall that gradually passes from horizontal to vertical so as to turn each book block accordingly (as it moves horizontally along its spine) for its next insertion into the feeding channel. However, the turning channel significantly increases a size of the perfect-binding machine. Particularly, this makes the turning channel unsuitable for perfect-binding machines of small size.

In any case, the use of the feeding channel prevents a full automated and continuous operation of the perfect-binding machine as the format of the book blocks changes. In fact, whenever the thickness of the book blocks changes the feeding channel has to be emptied before it may be adjusted accordingly. This involves a corresponding stop of the perfect-binding machine with a detrimental effect on its yield.

### SUMMARY

A simplified summary of the present disclosure is herein presented in order to provide a basic understanding thereof; however, the sole purpose of this summary is to introduce some concepts of the disclosure in a simplified form as a prelude to its following more detailed description, and it is not to be interpreted as an identification of its key elements nor as a delineation of its scope.

In general terms, the present disclosure is based on the idea of feeding the book blocks upwards from an inclined position.

Particularly, an aspect provides a bookbinding machine for processing book blocks. The bookbinding machine comprises a feeding device for feeding the book blocks to a loading station. The feeding device comprises an inclined support for supporting a front or a rear of each book block in a staging position below the loading station. A raising system raises the book block from the staging position to a loading position within the loading station; this comprises moving the book block transversally to its spine to put the book block in vertical position.

A further aspect provides a feeding device for use in the bookbinding machine.

A further aspect provides a bookbinding plant comprising one or more instances of the bookbinding machine.

A further aspect provides a corresponding method for feeding a bookbinding machine.

A further aspect provides a computer program for controlling the bookbinding machine to implement the method.

A further aspect provides a corresponding computer program product.

More specifically, one or more aspects of the present disclosure are set out in the independent claims and advantageous features thereof are set out in the dependent claims, with the wording of all the claims that is herein incorporated verbatim by reference (with any advantageous feature provided with reference to any specific aspect that applies mutatis mutandis to every other aspect).

### BRIEF DESCRIPTION OF THE DRAWINGS

The solution of the present disclosure, as well as further features and the advantages thereof, will be best understood with reference to the following detailed description thereof, given purely by way of a non-restrictive indication, to be read in conjunction with the accompanying drawings (wherein, for the sake of simplicity, corresponding elements are denoted with equal or similar references and their explanation is not repeated, and the name of each entity is generally used to denote both its type and its attributes, such as value, content and representation). In this respect, it is expressly intended that the drawings are not necessary drawn to scale (with some details that may be exaggerated and/or simplified) and that, unless otherwise indicated, they are merely used to illustrate the structures and procedures described herein conceptually. In addition, orientations and related position references (such as upper, lower, lateral and so on) are to be understood in relation to a condition of use of the corresponding entities. Particularly:

FIG. 1 shows a schematic representation of a bookbinding machine wherein the solution according to an embodiment of the present disclosure may be applied,

FIG. 2A-FIG. 2C show the general principles of a feeding device of the bookbinding machine according to an embodiment of the present disclosure,

FIG. 3 shows a pictorial representation of an implementation of the feeding device according to an embodiment of the present disclosure, and

FIG. 4A-FIG. 4F show operation of a portion of the feeding device according to an embodiment of the present disclosure.

### DETAILED DESCRIPTION

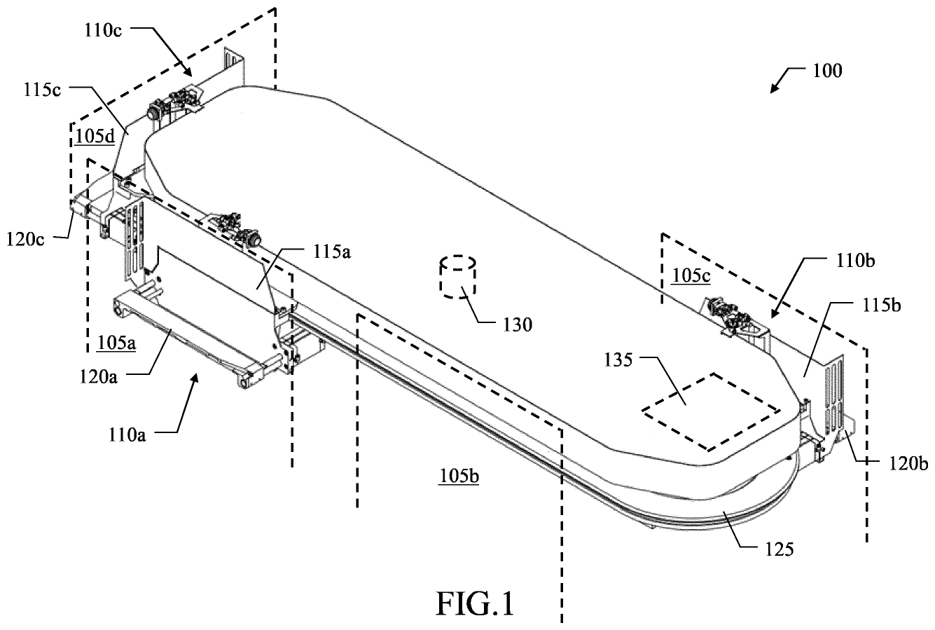

With reference in particular to FIG. 1, a schematic representation is shown of a bookbinding machine 100 wherein the solution according to an embodiment of the present disclosure may be applied.

Particularly, this is a (bookbinding) perfect-binding machine 100; the perfect-binding machine 100 is used for the production of books in bookbinding plants, and particularly to apply (soft) covers and/or fastening linings to corresponding book blocks, not shown in the figure. Each book block is formed by a block of signatures or sheets that are stacked one to another, either bound together (such as sewn or spot-glued) or not. The layers of the book block define corresponding pages of the book, from a front page to a rear page in reading order. The front page is generally provided with identification information of the book, such as in the form of text (title, author and so on) and/or in the form of a bar-code (indicating its format, processing operations, cover type and so on). The book block has two main sides, i.e., a front and a rear corresponding to the front page and to the rear page, respectively. Four minor sides of the book block are arranged between the front and the rear. Particularly, a side wherein the cover will be applied defines a spine and a side opposite thereto defines a lip; the sides connecting the lip to the spine define a head and a foot being up and down, respectively, in reading condition. The book block has a format defined by its width (between the lip and the spine), height (between the head and the foot) and thickness (between the front and the rear).

The perfect-binding machine 100 comprises the following components. A plurality of processing stations, four in the example at issue denoted with the references 105a, 105b, 105c and 105d, are distributed along a closed path within the perfect-binding machine 100 for processing the book blocks. At least part of the processing stations 105a-105d process the book blocks while they are stationary therein; for example, these (stationary) processing stations comprise a loading station 105a (for loading the book blocks to be processed in succession), a cover application station 105c (for applying the covers to the book blocks) and a delivering station 105d (for delivering the book blocks that have been processed). Optionally, one or more of the processing stations 105a-105e (the processing station 105b in the example shown in the figure) instead process the book blocks while they are moving thereacross; for example, the (movement) processing station 105b mills the book blocks and applies glue thereto. A plurality of clamps are used to transport the book blocks individually in the perfect-binding machine 100. The book-binding machine 100 has a relatively small size determined by a corresponding relatively low number of clamps (for example, 1-4), making it particularly suited for on-demand production of books (of different format) being printed digitally. In the example shown in figure, the book-binding machine 100 has three clamps denoted with the references 110a, 110b and 110c. In general, each clamp 110a-110c is a device being capable of holding each book block tightly by means of two jaws formed by corresponding elements that are movable relative to each other. In the example at issue, each clamp 110a, 110b and 110c comprises a (bigger) jaw 115a, 115b and 115, respectively, and a (smaller) jaw 120a, 120b and 120c, respectively, facing each other horizontally at a lower portion of the jaw 115a-115c. In each clamp 110a-110c, the jaw 120a-120c may be moved horizontally with respect to the jaw 115a-115c (for example, by a pneumatic actuator) between an open condition of the clamp 110a-110c (with the jaw 120a-120c moved away from the jaw 115a-115c) and a closed condition of the clamp 110a-110c (with the jaw 120a-120c moved towards the jaw 115a-115c). The clamp 110a-110c holds each book block vertically, slightly above its spine (with a holding element, not shown in the figure, arranged above the jaw 120a-120c that prevents the book block from tilting).

A transport system 125 (visible only partially in the figure), being driven by a motor 130, transports the clamps 110a-110c, and then the corresponding book blocks as well, through the processing stations 105a-105d on an endless guide (with oval shape in the example at issue), passing through them in order from the loading station 105a to the delivering station 105d continually. The transport system 125 works intermittently (in a start-stop mode), so as to stop the clamps 110a-110c in the stationary processing stations 105a, 105c, 105d for the time required to perform the corresponding operations (for example, as described in WO-A-2021/130363 or in WO-A-2022/268734).

A control unit 135 (for example, an industrial PC) controls operation of the perfect-binding machine 100. Particularly, the control unit 135 comprises (not visible in the figure) a microprocessor or more (providing a logic capability of the control unit 135), a non-volatile memory (such as a ROM storing basic code for a bootstrap of the control unit 135), a volatile memory (such as a RAM used as a working memory by the microprocessor), a mass-memory (such as an SSD for storing programs and data) and controllers for peripherals units of the bookbinding machine (such as, in addition to the ones mentioned above, a touchscreen for entering command/data and displaying information, a drive for reading/writing removable storage units like USB keys and so on).

When the perfect-binding machine 100 is working, the following operations are performed continually during a series of operative cycles of the bookbinding machine 100 for each clamp 110a-110c (with the different operations that are performed concurrently for all the clamps 110a-110c in their corresponding positions within the perfect-binding machine 100, if necessary). These operations are performed under the control of a control program running on the control unit 135, the control program being stored in the mass memory and loaded (at least partially) into the working memory of the control unit 135 when the control program is running.

At a certain operative cycle, a (current) clamp 110a-110c is stopped in the loading station 105a and it is opened. At a next operative cycle, a (current) book block to be processed is loaded into the clamp 110a-110c with its spine facing downwards, at a processing height required to process the book block in the other processing stations 105b-105d. The clamp 110a-110c is then closed (thereby holding the book block). During corresponding next operative cycles, the clamp 110a-110c with its book block is transported through the following processing stations 105b-105c (by stopping in the cover application station 105c for the time required to apply the corresponding cover to the book block), so as to perform the corresponding operations, if necessary (which operations may differ among the book blocks). At a next operative cycle, the clamp 110a-110c is stopped in the delivering station 105d. The book block being processed is grasped around its spine, the clamp 110a-110c is opened and the book block is pulled down and delivered outside the perfect-binding machine 100 (for following bookbinding machines that complete the production of the corresponding book, such as case-in machines or three-knives trimming machines, not shown in the figure). At a next operative cycle, the clamp 110a-110c is closed and then transported to the loading station 105a to repeat the same operations continually.

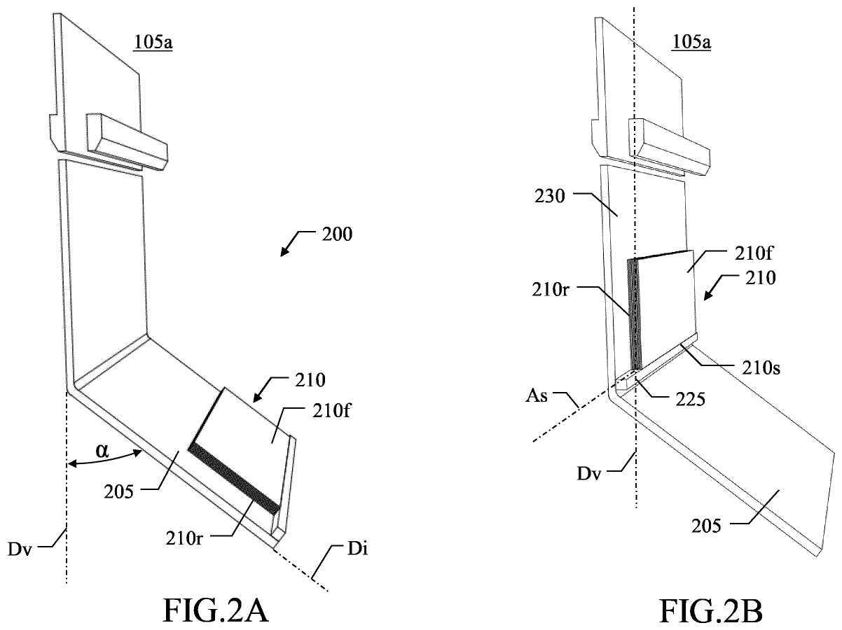

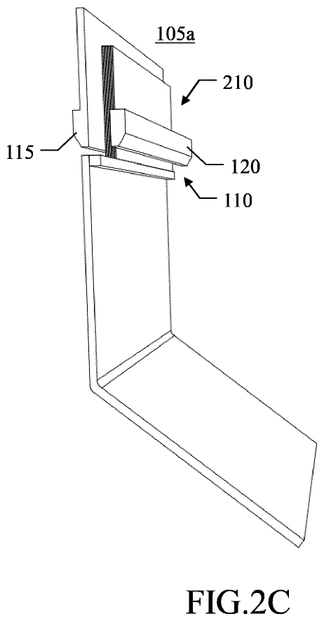

With reference now to FIG. 2A-FIG. 2C, the general principles are shown of a feeding device of the bookbinding machine according to an embodiment of the present disclosure.

Starting from FIG. 2A, the feeding device, denoted with the reference 200, is used to feed the book blocks in succession to the loading station 105a automatically (from preceding bookbinding machines providing the book blocks, such as sewing machines, not shown in the figure). For this purpose, an inclined support 205 (for example, a plate) is used to support each (current) book block to be feed to the loading station 105a, denoted with the reference 210. The inclined support 205 extends below the loading station 105a along an inclined direction Di with respect to a vertical direction Dv. This means that the inclined direction Di is neither parallel nor perpendicular to the vertical direction Dv; for example, the inclined direction Di and the vertical direction Dv form an angle a (facing downwards) of 25-55°, preferably 30-50°and still more preferably 35-45°, such as 40°. The inclined support 205 supports the book block 210 in a staging position, wherein the book block 210 rests with one of its main faces, i.e., its front or its rear denoted with the references 210f and 210r, respectively, and particularly with the rear 210r in the example shown in the figure, on the inclined support 205. The book block 210 rests on the inclined support 205 by gravity, and then independently of its format.

Moving to FIG. 2B, a raising system 225 (for example, comprising one or more pushers) is used to raise the book block 210 towards the loading station 105a. This comprises moving the book block 210 from the staging position (of FIG. 2A) to a vertical position wherein the book block 210 extends with the front 210f and the rear 210r along the vertical direction Dv. For this purpose, the book block 210 is moved transversally to a longitudinal axis As of the spine, denoted with the reference 210s (for example, by raising it along the inclined support 205 towards a vertical support 230).

Moving to FIG. 2C, in the end the book block 210 reaches a loading position, wherein it is inserted into a (current) clamp, generically denoted with the reference 110, being opened in the loading station 105a, i.e., with its jaws, generically denoted with the references 115 and 120, that are spaced apart. The book block 210 (again extending vertically) is now ready to be held by the clamp 110 once it is closed (with the jaw 120 moved towards the jaw 115).

The above-described solution works independently of the format of the book blocks in a relatively simple and fast way.

This solution then allows feeding book blocks of different format in succession seamlessly. As a result, it is possible to exploit a maximum speed of the perfect-binding machine, with a beneficial effect on its yield (thereby making it especially suited for the production of books on-demand).

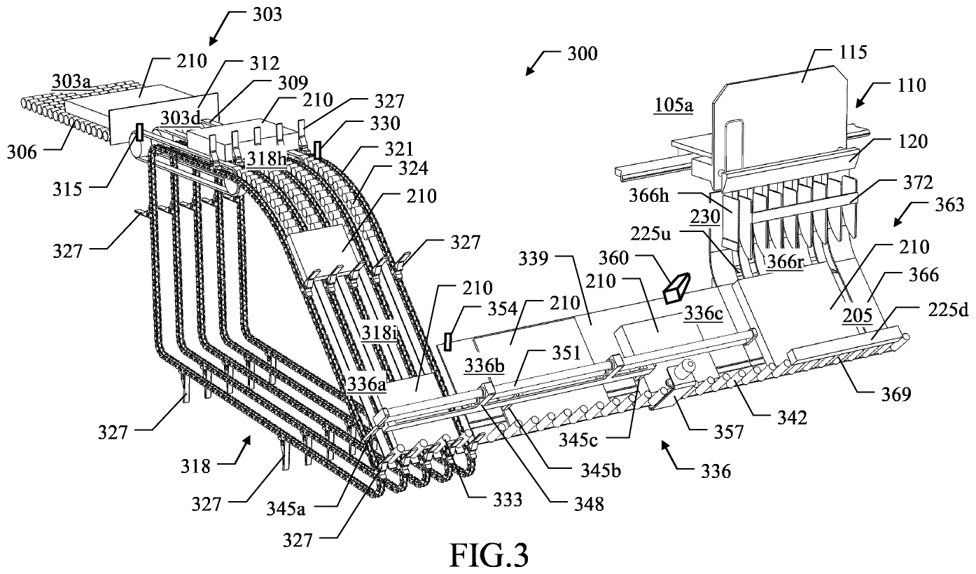

With reference now to FIG. 3, a pictorial representation is shown of an implementation of the feeding device according to an embodiment of the present disclosure.

The feeding device, differentiated with the reference 300, comprises the following components.

An entry transport system, or simply entry conveyor 303 extends horizontally in plain. The entry conveyor 303 comprises an accumulating segment 303a and a delivering segment 303d along a transport direction thereof (forwards in the figure). The accumulating segment 303a receives and accumulates the book blocks 210 coming from the preceding bookbinding machines (not shown in the figure); for this purpose, the accumulating segment 303a may be coupled at an input thereof along the transport direction of the entry conveyor 303 with a corresponding conveyor (not shown in the figure) that transports the book blocks 210 automatically from the preceding bookbinding machines to the feeding device 300. The accumulating segment 303a has a width greater than a maximum height of the book blocks 210 and a length greater than a maximum width of the book blocks 210 (such as 2-4 times it). For example, the accumulating segment 303a is implemented by a line of friction rollers 306. Therefore, any obstacle along the accumulating segment 303a stops the book blocks 210 (with the friction rollers 306 rotating in an idle way). The delivering segment 303d separates and individually delivers the book blocks 210 coming from the accumulating segment 303a. The delivering segment 303d has the same width as the accumulating segment 303a and a length greater than the maximum width of the book blocks 210. For example, the delivering segment 303d is implemented by a series of conveyor belts 309 (four in the example shown in the figure), arranged in parallel spaced apart one to another. A blocking device, for example, a shutter 312 separates the accumulating segment 303a and the delivering segment 303d, extending transversally to the transport direction of the entry conveyor 303. The shutter 312 may be moved (for example, by a pneumatic actuator, not shown in the figure) between an active position (wherein it is extracted above the delivering segment 303d so as to obstruct an input thereof along the transport direction of the entry conveyor 303) and a passive position (wherein it is retracted below the delivering segment 303d as to clear its input). A presence detector 315 (for example, based on a photo-cell) is arranged at the input of the delivering segment 303d for detecting the presence of any book block 210.

A lowering transport system, or simply lowering conveyor 318 is provided overlapping and following the entry conveyor 303 along its transport direction. The lowering conveyor 318 has the same width as the entry conveyor 303. The lowering conveyor 318 comprises a horizonal segment 318h extending horizontally and an inclined segment 318i extending downwards for transporting the book blocks 210 along a transport direction of the lowering conveyor 318 (forwards and downwards, respectively, in the figure). The horizontal segment 318h is intermingled with an output portion of the delivering segment 303d of the entry conveyor 303 (extending backwards from an output thereof along the transport direction of the entry conveyor 303), slightly below it. The inclined segment 318i extends from the horizontal segment 318h downwards along the same inclined direction of the inclined support (described in detail in the following). For example, the lowering conveyor 318 comprises a lowering support (for supporting the book blocks 210), which is implemented by a series of (endless) chains 321 (arranged in parallel spaced apart one to another, interdigitated with the conveyor belts 309) and a series of idle roller lines 324 (arranged among the chains 321 from the entry conveyor 303, aligned with the corresponding conveyor belts 309 and then slightly above the chains 321, to a position along the inclined section 318i, wherein they become flush with the chains 321). Each chain 321 carries a plurality of paddles (six in the example at issue), which are distributed uniformly along it; the corresponding paddles of the chains 321 are aligned transversally to the conveyor 318, so as to define corresponding drivers 327. The drivers 327 are distributed along the lowering conveyor 318 with a pitch greater than the maximum width of the book blocks 210 and ensuring that whenever a driver 327 has just passed the inclined segment 318i another driver 327 is in the horizontal segment 318h in correspondence to the entry conveyor 303. A width gauge 330 is arranged along the lowering conveyor 318 for measuring the width of each book block 210. For example, the width gauge 330 is implemented by a presence detector (such as a photo-cell) arranged at the horizontal segment 318h, so as to provide higher accuracy (alternatively, the same function is performed by the presence detector 315). A stopping element, for example, a barrier 333 projects perpendicularly above the inclined segment 318i at a lower end thereof for stopping each book block 210 transported by the lowering conveyor 318. For example, the barrier 333 is implemented by a series of pegs that are arranged among the chains 321 (so as not to interfere with the passage of the drivers 327).

A horizontal transport system, or simply horizontal conveyor 336 is provided overlapping and at a side of the lowering conveyor 318 (transversally thereto). The horizontal conveyor 336 has a width greater than the maximum width of the book blocks 210. The horizontal conveyor 336 comprises a horizontal support (for supporting the book blocks 210), which extends horizontally and it is slanted transversally along the same inclined direction of the inclined support (being aligned thereto). For example, the horizontal support is implemented by a lower portion of the inclined segment 318i (extending backwards from the barrier 333 along the transport direction of the lowering conveyor 318) and by a plate 339 that extends horizontally flush therewith. A sustaining element, for example, a barrier 342 projects perpendicularly above the plate 339 at a lower end thereof, aligned with the barrier 333. For example, the barrier 342 is implemented by a series of pegs extending the ones of the barrier 333. The barriers 333 and 342 define a sustaining element that is used to sustain the book blocks 210 during their transport along the horizontal support 318i,339. A plurality of (horizontal) pushers, three in the example at issue denoted with the references 345a, 345b and 345c, are used to push the book blocks 210 individually along a transport direction of the horizontal conveyor 336 away from the lowering conveyor 318 (rightwards in the figure). The pushers 345a-345c are supported by a bar 348, which is mounted on a (linear) axle 351 in parallel thereto. The axle 351 extends horizontally along the horizontal support 318i,339, above it at a distance greater than a maximum thickness of the book blocks 210. The pushers 345a-345c are distributed uniformly along the bar 348, with a pitch greater than the maximum height of the book blocks 210; the bar 348 is shorter than the axle 351, with their difference corresponding to the pitch of the pushers 345a-345c. The bar 348 may be moved with respect to the axle 351 (for example, by a mechanism driven by the motor of the bookbinding machine, not shown in the figure). Particularly, the bar 348 may be rotated around the axle 351 between an active position (wherein the bar 348 faces the horizontal support 318i,339 with the pushers 345a-345c extending towards it at a distance at most equal to a minimum thickness of the book blocks 210) and a passive position (wherein the bar 348 and the pushers 345a-345c face away from the horizontal support 318i,339). Moreover, the bar 348 may be translated along the axle 351 between a retracted position (wherein the bar 348 extends from an input of the horizontal support 318i,339 along the transport direction of the horizontal conveyor 336, leftmost in the figure) and an advanced position (wherein the bar 348 extends to an output of the horizontal support 318i,339 along the transport direction of the horizontal conveyor 336, rightmost in the figure). The pushers 345a-345c define a first segment 336a (at the lower portion of the inclined segment 318i), a second segment 336b (at a beginning of the plate 339 proximal to the inclined segment 318i) and a third segment 336c (at an end of the plate 339 distal from the inclined segment 318i) of the horizontal conveyor 336 along its transport direction, which segments 336a-336c are for corresponding stopping positions of the book blocks 210 in the horizontal conveyor 336. The (second) segment 336b is provided with a height gauge 354 for measuring the height of each book block 210. For example, the height gauge 354 is implemented by a presence detector (such as a photo-cell) being arranged at a beginning of the segment 336b along the transport direction of the horizontal conveyor 336 (leftmost in the figure). The (third) segment 336c is provided with a thickness gauge 357 for measuring the thickness of each book block 210. For example, the thickness gauge 357 is implemented by a position sensor arranged above the plate 339 (at a distance greater than the maximum thickness of the book blocks 210). Moreover, the segment 336c is provided with a bar-code reader 360 for reading the (possible) bar-code being printed on the front of each book block 210. For example, the bar-code reader 360 is implemented by a camera arranged above the plate 339 (at a distance greater than the maximum thickness of the book blocks 210).

A loading system, or simply loader 363 is provided at a side of the horizontal conveyor 336 opposite the lowering conveyor 318 (transversally thereto). The loader 363 implements the above-mentioned inclined support and raising system. For example, for this purpose the loader 363 comprises the following components. A plate 366 has a width greater than the maximum height of the book blocks 210. The plate 366 is bent to form, moving from the bottom to the top, an inclined segment (defining the above-mentioned inclined support and then denoted with the same reference 205), a rounded segment 366r and a vertical segment (defining the above-mentioned vertical support and then denoted with the same reference 230). The inclined segment 205 (extending along the inclined direction) is flush with the plate 339, with a length equal to its width. The vertical segment 230 (extending vertically below the loading station 105a) has a length greater than the maximum width of the book blocks 210; the vertical segment 230 is aligned with the jaw 115 of each clamp 110 when stopped in the loading station 105a (with a concave side of the plate 366 facing the jaw 120 of the clamp 110). The vertical segment 230 is also provided with a horizontal reference element, for example, a flap 366h. The flap 366h projects perpendicularly from the vertical segment 230 towards the concave side of the plate 366, aligned vertically with the pusher 345c when the bar 348 is in the advanced position. The rounded segment 366r links the inclined segment 205 and the vertical segment 230 (with a curvature radius and a length providing this result in a relatively smooth way). A sustaining element, for example, a barrier 369 projects perpendicularly above the inclined segment 205 at a lower end thereof, aligned with the barrier 342, for sustaining each book block 210 resting thereon (in the staging position). For example, the barrier 369 is implemented by a series of pegs extending the ones of the barrier 342. A guiding support, or simply guide 372 faces the vertical segment 230 in the concave side of the plate 366 (for guiding each book block 210 when extending vertically). The guide 372 may be moved horizontally (for example, by a mechanism driven by the motor of the bookbinding machine, not shown in the figure) to adjust its distance from the vertical segment 230 at least between the minimum thickness and the maximum thickness of the book blocks 210. For example, the guide 372 is implemented with a series of vertical flaps (parallel to one another), which are shaped to define a lower leading profile for each book block 210.

The above-mentioned raising system implemented by a (first raising) pusher and a (second raising) pusher, the latter only partially visible in the figure, which are differentiated with the references 225d and 225u, respectively. The pusher 225d,225u are used to push each book block 210 upwards along a transport direction of the loader 363. Particularly, the pusher 225d operates on the inclined segment 205 and the rounded segment 366r (in the concave side of the plate 366), moving along the inclined direction with a stroke between a lower position at the barrier 369 (corresponding to the staging position of the book block 210) and a higher position at a lower end of the vertical segment 230 (corresponding to the vertical position of the book block 210). The pusher 225u operates through the rounded segment 366r and on the vertical segment 230 (in the concave side of the plate 366), moving along the vertical direction with a stroke between a lower position below the vertical segment 230 (corresponding to the vertical position of the book blocks 210) and a higher position at the processing height of the book blocks 210 (corresponding to the loading position of the book blocks 210). The pusher 225d is implemented by a rack interdigitated with the barrier 369 and the pusher 225u is implemented by a similar rack interdigitated with the pusher 225d (so as not to interfere between each pair of them), with the rounded segment 366r having corresponding slots for the passage of the pushers 225d,225u. The pusher 225u is also provided with a jogger (not visible in the figure) for each book block 210 working towards the flap 336h (leftwards in the figure).

The above-described structure is relatively compact, so as to allow using it in a perfect-binding machine of small size as well.

In operation, the book blocks 210 coming from the preceding bookbinding machines are placed onto the accumulating segment 303a of the entry conveyor 303 with their rear resting thereon, their spine facing forwards and their head facing away from the loader 363 (leftwards in the figure). Therefore, the book blocks 210 have their front facing upwards, so that they may be inspected visually during their provision to the feeding device 300; moreover, this avoids any risk of damage/contamination of the front of the book blocks 210 by the conveyor 303. Normally, the shutter 312 is in the active position (extracted above the delivering segment 303d). Therefore, any book block 210 reaching the shutter 312 is stopped and aligned with its spine perpendicular to the transport direction of the entry conveyor 303. Any further book block 210 reaching this (stopped/aligned) book block, not shown in the figure, is stopped and aligned by it in the same way and so on, so that the book blocks 210 accumulate on the accumulating segment 303a in front of the delivering segment 303d. Therefore, the perfect-binding machine may be coupled with the preceding bookbinding machines seamlessly; moreover, the book blocks 210 may be provided from the preceding bookbinding machines with any alignment and pitch.

The feeding device 300 performs the following operations continually during a series of operative cycles of the bookbinding machine for each book block 210 that has reached it, being stopped behind the shutter 312 (with the different operations that are performed concurrently for any book blocks 210 in corresponding positions within the feeding device 300). These operations as well are performed under the control of the control program running on the control unit of the bookbinding machine (not shown in the figure).

At a corresponding operative cycle, the shutter 312 is lowered to the passive position (retraced below the delivering segment 303d). As a result, the accumulating segment 303a transports the book block 210 towards the delivering segment 303d. The delivering segment 303d runs at a speed slightly higher than a speed of the accumulating segment 303a. Therefore, when the delivering segment 303d takes over the book block 210 the latter is separated from any following book block 210 stopped behind it on the accumulating segment 303a. The presence detector 315 detects the book block 210 being present on the delivering segment 303d. As soon as the presence detector 315 does not detect the book block 210 any longer, meaning that it has completely left the accumulating segment 303a (or in any case after a pre-defined period after the shutter 312 has been moved to the passive position in case no book block is present on the accumulating segment 303a), the shutter 312 is raised to the active position to stop any following book block 210.

At a next operative cycle, the delivering segment 303d of the entry conveyor 303 transports the book block 210 towards the driver 327 at the horizontal segment 318h of the lowering conveyor 318, normally being in a stopped condition. As soon as the book block 210 reaches this driver 327 (for example, as detected by a corresponding pressure applied to the chains 321), the lowering conveyor 318 is started at the same speed of the delivering segment 303d. The delivering segment 303d continues transporting the book block 210 along the horizontal segment 318h, with the driver 327 moving synchronously ahead of it. When the book block 210 reaches the inclined segment 318i, it falls down by gravity onto the driver 327 that guides the book block 210 downwards along the inclined segment 318i. The book block 210 passes through the width gauge 330 that measures its width. For this purpose, the width gauge 330 determines an arrival time and a leaving time of the book block 210 (switching from being not present to being present and switching from being present to being not present, respectively). A transit time of the book block 210 is calculated from the arrival time to the leaving time and the width of the book block 210 is calculated by multiplying the transit time by the known speed of the lowering conveyor 318 (subtracting a known width of the driver 327). The width of the book block 210 is used later on to optimize its feeding to the loading station 105a (as described in the following). The same information may also be used to optimize operation of the perfect-binding machine. For example, it is possible to calculate a time required by the book block 210 to clear the corresponding clamp 110 in the delivering station (not shown in the figure) when it is pulled down therefrom, and then closing the clamp as soon as it has been cleared. Therefore, the corresponding jaw of the clamp may be moved more slowly (for a same available time) so as to reduce mechanical stresses and/or the operation may be performed more quickly for a same speed of the jaw. At the same time, another driver 327 reaches the horizontal segment 318h. At a next operative cycle, the book block 210 reaches the lower end of the inclined segment 318i (wherein the bar 348 is in the active position, with the pushers 345a-345c extending towards the horizontal support 318i,339, at the retracted position, with the pusher 345a at the (leftmost) input of the horizontal support 318i,339); therefore, the book block 210 is stopped by the barrier 333 (while the driver 327 passes through it). The lowering conveyor 318 is then stopped. At the same time, another driver 327 reaches the horizontal segment 318h.

At a next operative cycle, the bar 348 (in the active position) is translated along the axle 351 from the retracted position to the advanced position (rightwards in the figure). Therefore, the pusher 345a transports the book block 210 along the horizontal conveyor 336 from the segment 336a (at the lower end of the inclined segment 318i) to the segment 336b (at the beginning of the plate 339). The book block 210 passes through the height gauge 354 that measures its heigh. For this purpose, as above the height gauge 354 determines an arrival time and a leaving time of the book block 210 (switching from being not present to being present and switching from being present to being not present, respectively). A transit time of the book block 210 is calculated from the arrival time to the leaving time and the height of the book block 210 is calculated by multiplying the transit time by a known speed of the bar 348 (subtracting a known width of the pusher 345a). The height of the book block 210 is used to configure the perfect-binding machine (for example, for controlling the application of the glue, the cutting of the fastening lining and so on). The bar 348 is then rotated to the passive position (with the pushers 345a-345c away from the horizontal support 318i,339), translated back (leftwards) to the retracted position (without interfering with any book blocks 210 on the horizontal support 318i,339) and rotated again to the active position. At a next operative cycle, the bar 348 (in the active position) is again translated along the axle 351 from the retracted position to the advanced position. Therefore, the pusher 345b transports the book block 210 from the segment 336b to the segment 336c (at the end of the plate 339). Afterwards, the thickness gauge 357 measures the thickness of the book block 210 being stopped at the segment 336c. The thickness of the book block 210 is used later on to configure the loader 363 (as described in the following) and the perfect-binding machine (for example, for controlling pressing, milling, applying of glue, applying of end-paper, applying of fastening lining, applying of cover, delivering and so on). At the same time, the bar-code reader 360 reads the (possible) bar-code of the book block 210 being stopped at the segment 336c. The bar-code of the book block 210 is used later on to configure the perfect-binding machine (for example, for enabling the processing stations selectively, verifying a correctness of the applied cover and so on). The fact that these operations are performed while the book block 210 is stationary significantly simplifies them and then reduces a cost of the thickness gauge 357 and of the bar-code reader 360. The bar 348 is then rotated to the passive position, translated back to the retracted position and then rotated again to the active position. At a next operative cycle, the bar 348 (in the active position) is again translated along the axle 351 from the retracted position to the advanced position. Therefore, the pusher 345c transports the book block 210 from the segment 336c of the horizontal conveyor 336 to the inclined segment 205 of the loader 363 (wherein both the pushers 225d,225u are at their lower positions). As a result, the book block 210 is fully aligned on the loader 363. Particularly, the spine of the book block 210 is at a vertical reference defined by the barrier 369 (by gravity); the vertical reference ensures that the spine of the book block 210 is brought to its processing height by the pushers 225d,225u (according to their stroke). At the same time, the head of the book block 210 is at a horizontal reference defined by the pusher 345c; the horizontal reference corresponds to a processing alignment defined by a desired horizontal position of the book block 210 when loaded into the clamp 110 for its processing in the bookbinding machine, for example, having its head aligned with a corresponding edge of the clamp 110 (leftwards in the figure). This result is achieved independently of the format (width and height, respectively) of the book block 210.

At a next operative cycle, the guide 372 is adjusted to be at a distance from the vertical segment 230 slightly higher than the thickness of the book block 210 (as measured before by the thickness gauge 357). For example, the distance exceeds the thickness of the book block 210 by a fixed amount (such as 15mm) or by an amount depending on the thickness of the book block 210, and particularly increasing with it (such as equal to a fixed value, like 10 mm, plus a percentage of the thickness, like 10%). This operation may be performed after a preceding book block has been loaded into the clamp 110 (not shown in figure), for example, once the clamp 110 has been closed.

The pusher 225d is then raised from the lower position (at the barrier 369) to the higher position (at the lower end of the vertical segment 230), so as to bring the book block 210 from the staging position to the vertical position (inserting it between the vertical segment 230 and the guide 372). Meanwhile, a clamp 110 (being closed with its jaws 115 and 120 close to each other) reaches the loading station 105a and it is stopped. The clamp 110 is then opened; for this purpose, the jaw 120 is moved away from the jaw 115 to a distance therefrom slightly higher than the thickness of the book block 210. At the same time, the pusher 225u is raised from the lower position (below the vertical segment 230) to the higher position (at the processing height of the book block 210), so as to take over the book block 210 and bring it from the vertical position to the loading position; in this phase, the jogger pushes the book block 210 towards the flap 366h, so as to ensure its full alignment with the horizontal reference (corresponding to the processing alignment of the book block 210) in every condition, even when the book block 210 has been brought slightly beyond it by the pusher 345c. The pusher 225d is then returned to its lower position.

As a result, the book block 210 is inserted into the clamp 110 (with the spine at the processing height just below the clamp 110 and the head at the processing alignment at the leftmost edge of the clamp 110). At this point, the clamp 110 is closed by moving the jaw 120 towards the jaw 115 until it abuts against the book block 210 (thereby clamping it). The pusher 225u is then returned to its lower position.

The above-described structure allows feeding the book blocks 210 to the loading station 105a in a completely automatic way. Particularly, the book blocks 210 are transported to the loader 363 independently of their formats. Therefore, book blocks 210 of different formats may be present at the same time in the feeding device 300 (as shown in the figure), with a beneficial effect on its yield. In the loader 363, only the guide 372 is adjusted (if necessary) according to the thickness of the corresponding book block 210. In fact, the plate 366 has its vertical segment 230 aligned with a reference plane of the clamp 110, defined by the position of the jaw 115 when the clamp 110 is stopped in the loading station 105a. Therefore, each book block 210, resting on the plate 366 and raised along it, has a reference plane of the book block 210 defining a zero plane of its thickness (particularly, the rear of the book block 210 when it rests on the plate 366 with its front facing away therefrom) always aligned with the reference plane of the clamp 110. This allows a full automated and continuous operation of the perfect-binding machine 100 as the format of the book blocks changes. If necessary, the book blocks 210 may also be fed manually to the perfect-binding machine.

Particularly, an operator of the bookbinding machine may place the book blocks 210 onto the accumulating segment 303a of the entry conveyor 303 by hand as above. The feeding device 300 then works in the same manner, thereby exploiting all its advantages in this case as well. For example, the book blocks 210 may be fed manually to the accumulating segment 303a in case of book blocks coming from preceding bookbinding machines that are offline (i.e., not coupled with the feeding device 300).

Alternatively, the book blocks 210 may also be fed to the perfect-binding machine manually as usually. For this purpose, the operator sets the feeding device 300 to a manual mode (by entering a corresponding command onto the touch-screen of the perfect-binding machine). In response thereto, the pusher 225u is raised to a supporting position, at the processing height of the book blocks 210, and the feeding device 300 is stopped. In this condition, the operator may load the book blocks 210 from above into each clamp 110 stopped and opened in the loading station 105a, with their spines resting on the pusher 225u. For example, the book blocks 210 may be fed manually to the loading station 105a in case the perfect-binding machine is offline (i.e., not coupled with any preceding bookbinding machines).

In both cases, the feeding of the perfect-binding machine may be switched between its automatic mode and manual mode in a very simple and fast way.

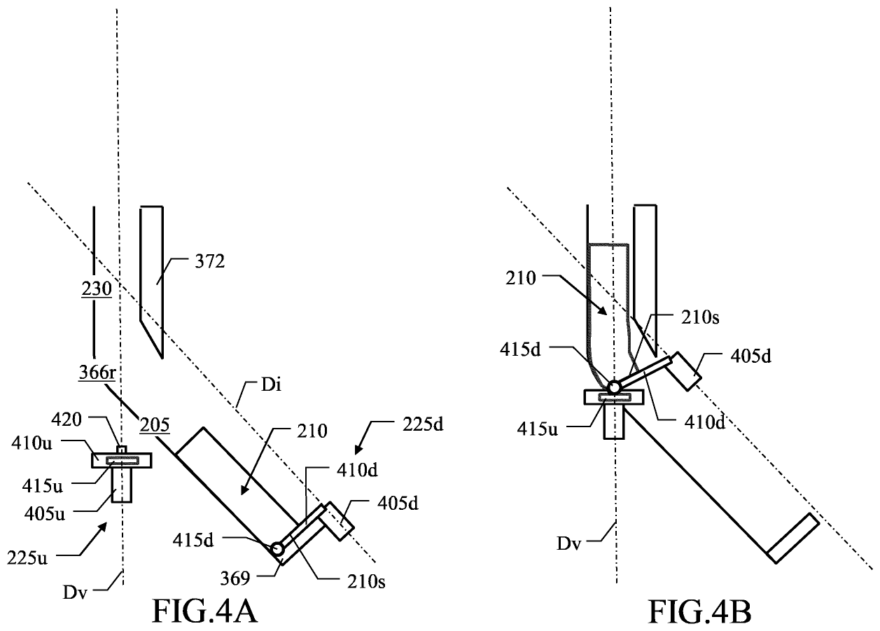

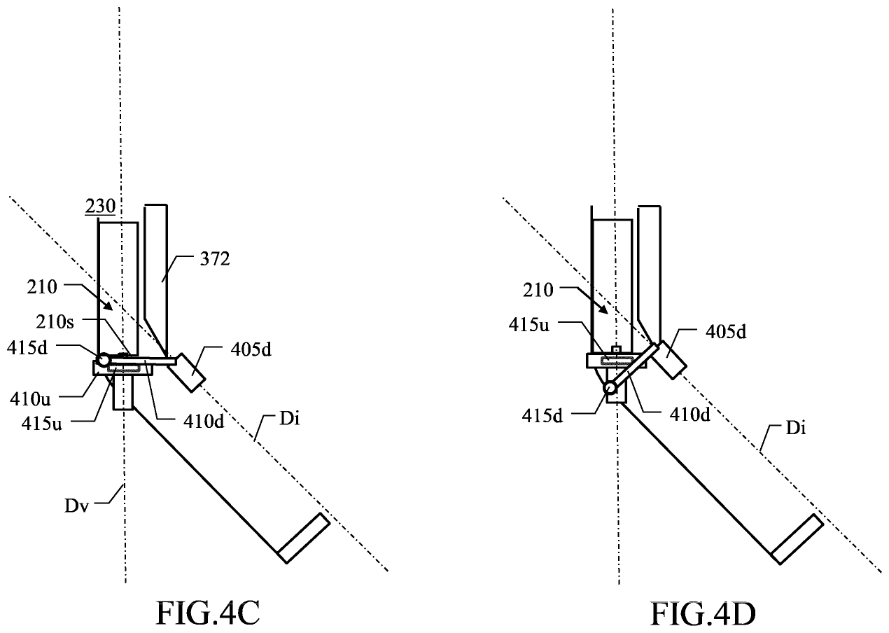

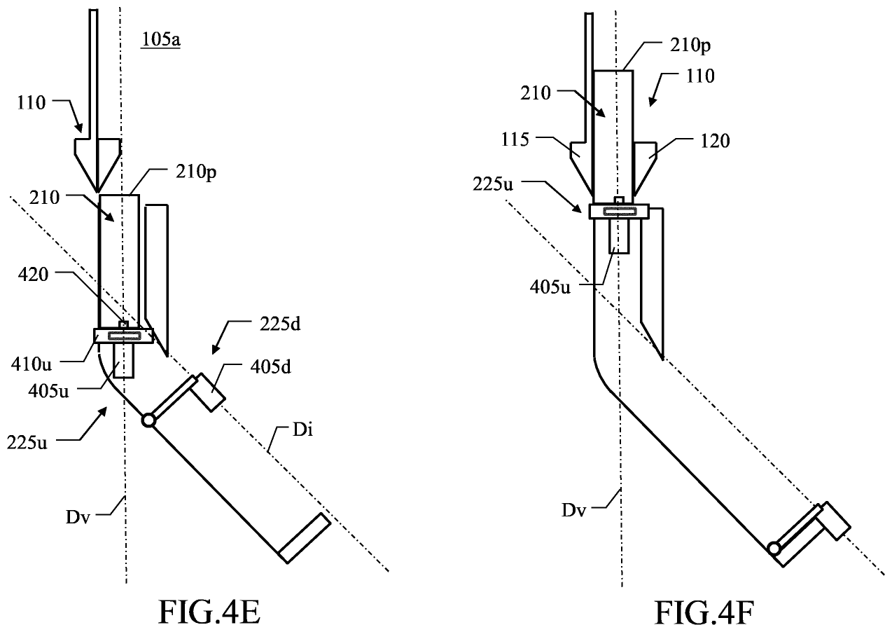

With reference now to FIG. 4A-FIG. 4E, operation is shown of a portion of the feeding device according to an embodiment of the present disclosure.

In this specific implementation, the pusher 225d comprises the following components. A driving element, for example, a carriage 405d being operated by a chain (not shown in the figure), moves along the inclined direction Di (with the corresponding stroke between the lower position and the higher position). An active element, for example, a rack 410d is driven by the carriage 405d for acting on (the spine 210s of) each book block 210. The rack 410d may pivot around the carriage 405d. The rack 410d is biased to different (angular) positions for changing a direction of its action on the book block 210. For this purpose, in a specific implementation the rack 410d is provided with a follower (or more) 415d (for example, a lateral bar ending with an idle wheel). In the condition shown in figure, when the carriage 405d is in the lower position at the barrier 369 (corresponding to the staging position of the book block 210), the follower 415d is biased (for example, by gravity) so as to cause the rack 410d to act on the book block 210 along the inclined direction Di (i.e., with the rack 410d perpendicular thereto). Moreover, the pusher 225u comprises the following components. A driving element, for example, another carriage 405u being operated by a chain (not shown in the figure), moves along the vertical direction Dv (with the corresponding stroke between the lower position and the higher position). An active element, for example, another rack 410u is driven by the carriage 405u for acting on (the spine 210s of) the book block 210 along the vertical direction Dv. A biasing element, a cam 415u (or more) in the example at issue, is driven by the carriage 405u as well for biasing the follower 415d differently. The rack 410u is also provided with the jogger, denoted with the reference 420.

Once the book block 210 has been provided to the inclined segment 205 (in the staging position) and the distance of the guide 372 from the vertical segment 230 has been adjusted according to the thickness of the book block 210, the carriage 405d starts moving upwards along the inclined direction Di from the lower position (at the barrier 369) to the higher position (at the lower end of the vertical segment 230), so as to bring the book block 210 from the staging position to the vertical position. In an initial part of the stroke of the carriage 405d, the rack 410d acts on the book block 210 along the inclined direction Di (i.e., on its spine 210s being inclined perpendicularly thereto), thereby pushing it on the inclined segment 205, then on the rounded segment 366r and then on the vertical segment 230; as a result, the book block 210 bends accordingly, starting inserting between the vertical segment 230 and the guide 372. As soon as the carriage 405d reaches a position corresponding to the lower position of the carriage 405u (at the lower end of the vertical segment 230), with the follower 415d slightly above the cam 415u, the carriage 405u as well starts moving upwards along the vertical direction Dv from the lower position (below the vertical segment 230) to the higher position (at the processing height of the book block 210), with the same speed (in modulus) of the carriage 405d. The (full) speed of the carriage 405u along the vertical direction Dv is higher than a component of the speed of the carriage 405d along the vertical direction Dv; therefore, the cam 415u moves upwards relative to the follower 415d. Moreover, the speed of the carriage 405d has a horizontal component (towards the carriage 405u, leftwards in the figure), being instead absent in the speed of the carriage 405u; therefore, the follower 415d moves laterally relative to the cam 415u (towards it).

Moving to FIG. 4B, as a result the cam 415u reaches the follower 415d thereby engaging it. The cam 415u then raises the follower 415d vertically with respect to the carriage 405d; at the same time, the follower 415d slides horizontally along the cam 415u away from the carriage 405d. This causes the follower 415d to rotate with respect to the carriage 405d (clockwise in the figure), thereby rotating the rack 410d (integral therewith) accordingly. As a consequence, the direction of action of the rack 410d on the book block 210 reduces its inclination (with respect to the vertical direction Dv), thereby reducing the inclination of the spine 210s accordingly.

Moving to FIG. 4C, as a result the book block 210 bends accordingly until it reaches its vertical position (returning straight with the spine 210s extending horizontally, being inserted between the vertical segment 230 and the guide 372). At this point, the direction of action of the rack 410d on the book block 210 has reduced its inclination to zero, with the follower 415d now extending horizontally that has reached a (leftmost) end of the cam 415u. Therefore, in a final portion of the stroke of the carriage 405d, the direction of action of the rack 410d on the book block 210 changes progressively from the inclined direction Di to the vertical direction Dv. The rack 410u now takes over the book block 210, by acting on its spine 210s along the vertical direction Dv. The above-described structure provides a smooth transition from the rack 410d to the rack 410u, thereby avoiding (or at least substantially reducing) any recoil on the book block 210.

Moving to FIG. 4D, the follower 415d passes beyond the cam 415u so as to disengage from it. As a consequence, the follower 415d and the rack 410d integral therewith fall down (by gravity). This causes the follower 415d and the rack 410d to rotate with respect to the carriage 405d (counterclockwise in the figure), so as to return to their initial position (perpendicular to the inclined direction Di) and then leaving the book block 210.

Moving to FIG. 4E, the carriage 405d moves downwards along the inclined direction Di towards its lower position. The carriage 405u instead continues moving upwards along the vertical direction Dv; the rack 410u then pushes the book block 210 upwards, until it reaches a waiting position wherein the book block 210 has its lip, denoted with the reference 210p, in correspondence to a lower end of the clamp 110 in the loading station 105a (for example, below it at a distance of 5-20 mm). The corresponding height of the carriage 405u is determined according to the width of the book block 210. The carriage 405u is now stopped. In this phase, the jogger 420 is enabled so as to jog the book block 210 towards its head (against the flap of the vertical segment, not shown in the figure). The fact that the head of the book block 210 is substantially already correctly aligned significantly simplifies this operation, since the jogger 420 only needs to re-align individual signatures/sheets that might be shifted during the transport of the book block 210. Moreover, the fact that the book block 210 is jogged during its raising allows saving a corresponding time for the loading of the book block 210 into the clamp 110; as a result, the pusher 225u may be moved more slowly so as to reduce mechanical stresses (especially important in case of heavy book blocks) and/or the loading may be performed more quickly for a same speed of the pushers 225d,225u.

Moving to FIG. 4F, as soon as the clamp 110 has been opened, the carriage 405u resumes moving upwards along the vertical direction Dv (with either the same or a different speed) to its higher position, so as so as to bring the book block 210 from the waiting position to the loading position, wherein it is inserted into the clamp 110 (at its processing height). The operation is optimized by the fact that the lip 210p of the book block 210 is already just below the clamp 110 (independently of the width of the book block 210). For example, the pusher 225u may be moved more slowly in case of book blocks with small width (for a same available time) so as to reduce mechanical stresses (especially important in case of heavy book blocks) and/or the operation may be performed more quickly for a same speed of the pusher 225u. At this point, the clamp 110 is closed by moving the jaw 120 towards the jaw 115 until it abuts against the book block 210 (thereby clamping it). The clamp 110 (with the book block 210) is restarted and the carriage 405u is moved downwards along the vertical direction Dv to its lower position, thereby returning to the condition of FIG. 4A.

### Modifications

In order to satisfy local and specific requirements, a person skilled in the art may apply many logical and/or physical modifications and alterations to the present disclosure, provided that it remains within the scope of the claims. More specifically, although this disclosure has been described with a certain degree of particularity with reference to one or more embodiments thereof, it should be understood that various omissions, substitutions and changes in the form and details as well as other embodiments are possible. Particularly, different embodiments of the present disclosure may be practiced even without the specific details (such as the numerical values) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the present disclosure may be incorporated in any other embodiment as a matter of general design choice. Moreover, items presented in a same group and different embodiments, examples or alternatives are not to be construed as de facto equivalent to each other (but they are separate and autonomous entities). In any case, each numerical value should be read as modified according to applicable tolerances; particularly, unless otherwise indicated, the terms “substantially”, “about”, “approximately” and the like should be understood as within 10%, preferably 5% and still more preferably 1%. Moreover, each range of numerical values should be intended as expressly specifying any possible number along the continuum within the range (comprising its end points). Ordinal or other qualifiers are merely used as labels to distinguish elements with the same name but do not by themselves connote any priority, precedence or order. The terms include, comprise, have, contain, involve and the like should be intended with an open, non-exhaustive meaning (i.e., not limited to the recited items), the terms based on, dependent on, according to, function of and the like should be intended as a non-exclusive relationship (i.e., with possible further variables involved), the term a/an should be intended as one or more items (unless expressly indicated otherwise), and the term means for (or any means-plus-function formulation) should be intended as any structure adapted or configured for carrying out the relevant function.

For example, an embodiment provides a bookbinding machine. However, the bookbinding machine may be of any type (for example, a perfect-binding machine, a case-in machine and so on).

In an embodiment, the bookbinding machine is for processing book blocks. However, the book blocks may be of any type (for example, formed by signatures, flat sheets, with or without inserts, bound together in any way, such as glued, sewn, stapled and the like, freely stacked and so on) and they may be processed in any way (for example, loading, pressing, milling, applying glue, applying end-papers, applying fastening linings, applying covers, delivering and so on).

In an embodiment, the bookbinding machine comprises one or more clamps for transporting the book blocks individually in the bookbinding machine. However, the clamps may be in any number and of any type (for example, with pneumatic/hydraulic control, with a fixed jaw and a movable jaw, with two movable jaws, with the jaws translating and/or rotating, and so on).

In an embodiment, the bookbinding machine comprises a loading station for loading each current one of the book blocks into each current one of the clamps being therein. However, the loading station may be of any type (for example, only for automatic loading, with the possibility of manual loading as well, with or without stopping the current clamp in the loading station for this purpose, and so on).

In an embodiment, the bookbinding machine comprises a feeding device for feeding the book blocks in succession to the loading station. However, the feeding device may be of any type (for example, for working online and/or offline, with the book blocks that are provided thereto in any way, such as laterally via a horizontal transport system and a possible lowering transport system, from above and so on).

In an embodiment, the feeding device comprises an inclined support for supporting the current book block in a staging position. However, the inclined support may be of any size and type (for example, a segment of a feeding support, a stand-alone support, based on a plate, a roller-bed and so on).

In an embodiment, the inclined support extends below the loading station along an inclined direction (with respect to a vertical direction) in condition of use. However, the inclined direction may form any angle with the vertical direction and the inclined support may be at any distance below the loading station.

In an embodiment, the inclined support is for supporting the current book block in a staging position wherein the current book block rests with a main side (being a front or a rear thereof) on the inclined support. However, the book blocks may rest on the inclined support in any way (for example, all with their rear, all with their front, in part with their rear and in part with their front, and so on).

In an embodiment, the feeding device comprises a raising system for raising the current book block from the staging position to a loading position. However, the raising system may be of any type (for example, based on one or more pushers, pliers, raising the book block from the staging position to the loading position passing through a waiting position or directly, and so on).

In an embodiment, the current book block in the loading position is inserted into the current clamp being opened in the loading station. However, the clamp may be opened in any way (for example, in the loading station or before reaching it at least in part, at any speed, according to the thickness of the current book block or by a fixed extent, and so on).

In an embodiment, the raising of the current book block comprises moving the current book block transversally to a longitudinal axis of a spine thereof from the staging position to a vertical position wherein the current book block extends with the front and the rear along the vertical direction. However, the vertical position may be of any type (for example, below the loading position, either aligned or displaced vertically, at the same height of the loading position, coinciding with the loading position and so on) and it may be reached in any way (for example, by raising the current book block along the inclined support, by turning the inclined support and so on).

Further embodiments provide additional advantageous features, which may however be omitted at all in a basic implementation.

In an embodiment, the bookbinding machine is configured to stop the current clamp in the loading station for loading the current book block. However, the possibility is not excluded of loading the current book block into the current clamp while passing through the loading station (for example, moving the current book block upwards obliquely and so on).

In an embodiment, the raising system is configured for raising the current book block from the staging position to the vertical position (by moving transversally to the longitudinal axis of the spine along the inclined direction) and for raising the current book block from the vertical position to the loading position (by moving transversally to the longitudinal axis of the spine along the vertical direction). However, the current book block may be raised from the staging position to the vertical position and then to the loading position in any way (for example, by corresponding elements in succession, by a single element and so on).

In an embodiment, the feeding device comprises a vertical support for supporting the current book block during said raising the current book block from the vertical position to the loading position. However, the vertical support may be of any size and type (for example, a segment of a feeding support, a stand-alone support, based on a plate, a roller-bed and so on) or it may also be missing (for example, when the vertical position is the same as the loading position).

In an embodiment, the vertical segment is aligned with a stopping position in the loading station of a fixed jaw of the current clamp. However, the vertical support may be aligned with the current clamp in any way (for example, with the inner/outer jaw of the clamp, at any distance below it and so on).

In an embodiment, the feeding device comprises a feeding support for supporting the current book block on a concave side thereof. However, the feeding support may be of any size and type (for example, with any width, profile, uniform/non-uniform, based on a plate, a roller-bed and so on).

In an embodiment, the feeding support comprises an inclined segment defining the inclined support, a vertical segment defining the vertical support and a rounded segment linking the inclined segment and the vertical segment. However, the segments may be of any type (for example, with any lengths, with any radius of curvature for the rounded segment or even without it in case the vertical segment and the inclined segment are connected directly or are separated to each other, and so on).

In an embodiment, the feeding device comprises one or more raising pushers for pushing the current book block from the staging position to the loading position. However, the pushers may be in any number and of any type (for example, each implemented by a rack, a plate and so on).

In an embodiment, the raising pushers comprise a first raising pusher for pushing the current book block from the staging position to the vertical position and a second raising pusher for pushing the current book block from the vertical position to the loading position. However, the two raising pushers may work in any way (for example, cooperating to exchange the current book block from the first raising pusher to the second raising pusher, with the first raising pusher that brings the current book block to the vertical position wherein it is taken over by the second raising pusher, and so on).

In an embodiment, the first raising pusher comprises a driving element movable along the inclined direction. However, the driving element may be of any type (for example, a carriage, a plate, a piston and so on).

In an embodiment, the first raising pusher comprises an active element being driven by the driving element for acting on the spine of the current book block. However, the active element may be of any type (for example, a rack, a plate and so on).

In an embodiment, the active element is pivotable around the driving element. However, this result may be achieved in any way (for example, by means of a hinge, a joint and so on).

In an embodiment, the active element pivots for acting on the spine of the current book block along the inclined direction in correspondence to said moving the current book block from the staging position towards the vertical position and progressively from the inclined direction to the vertical direction in correspondence to the vertical position of the current book block. However, the active element may pivot in any way (for example, biased to act along the inclined direction by gravity, a spring and the like, and biased to act from the inclined direction to the vertical direction by one or more biasing elements moving with the second raising pusher or being in a fixed position, acting at one or both sides of the first raising pusher, and so on) for changing its direction of action in any way (in any portion of the stroke of the first raising pusher corresponding to the vertical position, either reaching or not the corresponding end-of-stroke, with any motion law, with any uniform/non-uniform speed and so on).

In an embodiment, the second raising pusher comprises a biasing element for biasing the active element progressively from the inclined direction to the vertical direction in correspondence to the vertical position of the current book block. However, the biasing element may be of any type for biasing the active element in any way (for example, a cam for a follower, a slot for a pin and so on).

In an embodiment, the bookbinding machine comprises an input unit for setting the feeding device to a manual mode. However, the input unit may be of any type (for example, local/remote, a touch-screen, a keypad, a network card and so on).

In an embodiment, in the manual mode one of the raising pushers is maintained at a supporting position below the loading station in condition of use for supporting each of the book blocks being inserted manually from above into the current clamp being opened in the loading station. However, this result may be achieved in any way (for example, with any one of the pushers, a dedicated element and so on).

In an embodiment, the feeding device comprises a horizontal transport system for transporting the book blocks in succession to the inclined support horizontally in condition of use. However, the horizontal transport system may be of any type (for example, working intermittently/continuously along any transport direction, based on one or more pushers, a roller conveyor, a belt conveyor and so on).

In an embodiment, the horizontal transport system comprises a horizontal support being aligned with the inclined support for supporting one or more of the book blocks resting with the main side thereon. However, the horizontal support may be of any type (for example, with any length, either movable or fixed, such as a plate, a bed of rollers, a belt and the like, comprising a portion of the possible lowering transport system or not, and so on).

In an embodiment, the horizontal transport system comprises one or more horizontal pushers for pushing the book blocks individually along the horizontal support to the inclined support. However, the horizontal pushers may be in any number and of any type (for example, mounted on a sliding bar, an endless chain and so on).

In an embodiment, the current book block in the staging position is aligned with a horizontal reference of the loading station in condition of use by a last one of the horizontal pushers along a transport direction of the horizontal transport system. However, the book block may be aligned in any way (for example, only by the last pusher, biasing the book block in the opposite direction on the inclined support, such as by an additional pusher, frictional rollers and so on) with respect to any horizontal reference (for example, corresponding to any edge of the current clamp when stopped in the loading station, and so on).

In an embodiment, the horizontal pushers are configured for pushing the book blocks individually through one or more stopping positions along the horizontal support. However, the stopping positions may be in any number (either the same or different with respect to the number of the horizontal pushers) and of any type (for example, size, stopping time and so on).

In an embodiment, the raising system comprises a jogger for jogging the current book block with respect to the horizontal reference. However, the jogger may be of any type (for example, provided in any one of the raising pushers, in the inclined support, as a stand-alone element, working along any direction and so on).

In an embodiment, the jogger is for jogging the current book block during said raising the current book block from the staging position to the loading position. However, the book block may be jogged during any phase of its raising (for example, while raising from the staging position to the waiting position, in the waiting position, while raising from the waiting position to the loading position and so on).

In an embodiment, the feeding device comprises a lowering transport system for transporting the book blocks in succession to the horizontal transport system downwards in condition of use. However, the lowering transport system may be of any type (for example, working intermittently/continuously, based on drivers, plows, forks, flights and the like, of free-falling type and so on).

In an embodiment, the lowering transport system comprises a lowering support extending at least in part downwards in condition of use for supporting one or more of the book blocks resting with the main side thereon. However, the lowering support may be of any type (for example, with any length, either movable or fixed, such as one or more chains, one or more belts, a plate and so on) and it may extend downwards in any way (for example, with a horizonal segment and an inclined segment, only with an inclined segment, with the inclined segment having a slope that is uniform or increases moving downwards, and so on).

In an embodiment, the lowering transport system comprises one or more drivers being movable along a transport direction of the lowering transport system for sustaining the spine of the book blocks individually during said transporting the book blocks downwards. However, the drivers may be in any number, with any pitch and of any type (for example, each implemented by any number of paddles, a rod and so on).

In an embodiment, the feeding system comprises a sustaining element projecting above the inclined support in condition of use for sustaining the spine of the current book block in the staging position. However, the sustaining element may be of any type (for example, a barrier, a plate, a fence and the like projecting above the inclined support in any direction, with any height and so on); in any case, the possibility is not excluded of using the raising system (for example, a raising pusher thereof) for sustaining the current book block in the staging position.

In an embodiment, the feeding system comprises a further sustaining element projecting above the horizontal support in condition of use for stopping each of the book blocks at a lower end of the lowering support and for sustaining the book blocks during said transporting the book blocks horizontally, wherein the further sustaining element is aligned with the sustaining element. However, the further sustaining element may be of any type (for example, either the same or different with respect to the sustaining element, formed by a single component or by separate components for stopping and for sustaining the book blocks); in any case, the possibility is not excluded of using each driver for stopping the corresponding book block at the lower end of the lowering support.

In an embodiment, the feeding device comprises one or more gauges for measuring corresponding characteristics of each of the book blocks. However, the gauges may be in any number, at any position and for measuring any characteristics of the book blocks (for example, width, length, thickness, bar-code, NFC tag, text and so on); in any case, each of the gauges (up to all of them) may also be missing (for example, when the corresponding information is received from a previous bookbinding machine providing the book blocks, is entered manually by an operator, is retrieved from corresponding codes being read from the book blocks, it is not used and so on).

In an embodiment, the bookbinding machine comprises a control unit. However, the control unit may be of any type (for example, a computer, a micro-controller and so on).

In an embodiment, the control unit is for controlling the bookbinding machine according to the characteristics of the book blocks. However, the bookbinding machine may be controlled according to the characteristics of the book blocks in any way (for example, controlling its processing stations and/or the feeding device, configuring and/or optimizing them, in partial, different and additional ways with respect to the ones mentioned above, and so on).

In an embodiment, the gauges comprise a thickness gauge for measuring a thickness of each book block. However, the thickness gauge may be of any type (for example, based on a position sensor, a laser and so on) and at any position (for example, in the horizontal transport system, the lowering transport system, the loading system and so on).

In an embodiment, the gauges comprise a height gauge for measuring a height of each book block. However, the height gauge may be of any type (for example, based on a presence detector, a measurer and so on) and at any position (for example, in the horizontal transport system, the lowering transport system, the loading system and so on).

In an embodiment, the gauges comprise a width gauge for measuring a width of each of the book blocks. However, the width gauge may be of any type (for example, based on a presence detector, a measurer and so on) and at any position (for example, in the lowering transport system, the horizontal transport system, the loading system and so on).

In an embodiment, the raising system comprises a guiding element for guiding the current book block during said raising the current book block from the vertical position to the loading position. However, the guiding element may be of any type (for example, formed by the vertical support and a guiding support, a dedicated structure, based on a rake, a plate, with or without a lower leading profile, and so on) or it may also be missing (for example, when the vertical position is the same as the loading position).

In an embodiment, the control unit is configured for setting a width of the guiding structure according to the thickness of the current book block. However, the width of the guiding structure may be set in any way (for example, exceeding the width of the book block by any extent, either fixed or depending on the thickness of the current book block according to any linear/non-linear law, with any advance to the insertion of the book block therein and so on).

In an embodiment, the height gauge is arranged along the horizontal transport system. However, the height gauge may be arranged along the horizontal transport system in any way (for example, in any segment, at a side, above, below and so on).

In an embodiment, the thickness gauge is arranged along the horizontal transport system. However, the thickness gauge may be arranged along the horizontal transport system in any way (for example, in any segment, above, at a side and so on).

In an embodiment, the thickness gauge is arranged for measuring the thickness of each of the book blocks being stopped at one of the stopping positions. However, the thickness gauge may measure the thickness in any way (for example, while the book block is stopped at any position, is moving and so on).

In an embodiment, the width gauge is arranged along the lowering transport system. However, the width gauge may be arranged along the lowering transport system in any way (for example, in the horizontal segment, the inclined segment, at a side, above, below and so on).

In an embodiment, the raising system is configured for raising the current book block from the staging position to a waiting position wherein the current book block extends with the front and the rear along the vertical direction and with a lip thereof in correspondence to a lower end of the current clamp in the loading station in condition of use. However, the waiting position may be of any type (for example, with the lip at any distance, down to zero, from the current clamp, either fixed or depending on the width of the book block, with the waiting position above or below the vertical position, and so on) and the book block may be raised thereto in any way (for example, by two or more raising pushers in succession, by a single raising pusher and so on).

In an embodiment, the raising system is configured for raising the current book block from the waiting position to the loading position in response to the current clamp being opened in the loading station. However, this operation may be triggered in any way (for example, detecting the opening of the clamp by a corresponding sensor, estimating the opening of the clamp according to its control and so on) and the book block may be raised to the loading position in any way (for example, by the same raising pusher used to bring the book block to the waiting position, by one or more other raising pushers, either passing or not through the vertical position, and so on).

In an embodiment, the control unit is configured for setting the waiting position according to the width of the current book block. However, the waiting position may be set in any way (for example, to bring the lip of the current book block at any distance from the current clamp being fixed, depending on the width of the current book block and so on).

In an embodiment, the bookbinding machine is a perfect-binding machine. However, the perfect-biding machine may be of any type (for example, for applying covers in the production of soft-cover books, for applying fastening linings in the production of hard-cover books and so on).

An embodiment provides a feeding device for use in the bookbinding machine of above, the feeding device comprising the inclined support and the raising system. However, the feeding device may be put on the market directly integrated in (new) bookbinding machines, as a stand-alone product to be used with pre-existing bookbinding machines or as a modification (after-market) kit for application thereto.

A further embodiment provides a bookbinding plant comprising one or more instances of the bookbinding machine of above. However, the bookbinding plant may be of any type (for example, with any number of these bookbinding machines and any number and type of other preceding and/or following bookbinding machines, such as gathering machines, sewing machines, case-in machines, trimming machines and the like, with the bookbinding machines being online and/or offline among them, and so on).

Generally, similar considerations apply if the bookbinding machine, the feeding device and the bookbinding plant each has a different structure or comprises equivalent components or it has other operative characteristics, provided that it remains within the scope of the claims. In any case, every component thereof may be separated into more elements, or two or more components may be combined together into a single element; moreover, each component may be replicated to support the execution of the corresponding operations in parallel. Moreover, unless specified otherwise, any interaction between different components generally does not need to be continuous, and it may be either direct or indirect through one or more intermediaries.

A further embodiment provides a method for processing book blocks in a bookbinding machine. In an embodiment, the method comprises transporting the book blocks individually in the bookbinding machine by one or more clamps. In an embodiment, the method comprises loading each current one of the book blocks into each current one of the clamps being in a loading station. In an embodiment, the method comprises feeding the book blocks in succession to the loading station. In an embodiment, said step of feeding the book blocks comprises supporting the current book block (by an inclined support extending below the loading station along an inclined direction with respect to a vertical direction) in a staging position. In an embodiment, the current book block in the staging position rests with a main side (being a front or a rear thereof) on the inclined support. In an embodiment, said step of feeding the book blocks comprises raising the current book block from the staging position to a loading position (wherein the current book block is inserted into the current clamp being opened in the loading station). In an embodiment, said step of raising the current book block comprises moving the current book block transversally to a longitudinal axis of a spine thereof from the staging position to a vertical position (wherein the current book block extends with the front and the rear along the vertical direction). However, the same considerations pointed out above with respect to the features of the bookbinding machine apply to the corresponding steps of the method as well.

Generally, similar considerations apply if the same solution is implemented with an equivalent method (by using similar steps with the same functions of more steps or portions thereof, removing some non-essential steps or adding further optional steps), provided that it remains within the scope of the claims; moreover, the steps may be performed in a different order, concurrently or in an interleaved way (at least in part).

A further embodiment provides a computer program configured for causing a control unit of a bookbinding machine to control the bookbinding machine for performing the above-described method when the computer program is executed on the control unit. A further embodiment provides a computer program product comprising a computer readable storage medium embodying a computer program, the computer program being loadable into a working memory of a control unit of a bookbinding machine thereby configuring the control unit to perform the same method. However, the program may take any form suitable to be used by any control unit (see above), such as in the form of external or resident software, firmware, or microcode (either in object code or in source code, for example, to be compiled or interpreted). Moreover, it is possible to provide the program on any computer readable storage medium of tangible type, different from transitory signals per se (which may retain and store instructions for use by the control unit, such as of electronic, magnetic, optical, electromagnetic, infrared, or semiconductor type, like fixed disks, memory keys and so on). In any case, the solution according to an embodiment of the present disclosure lends itself to be implemented even with a hardware structure (for example, by electronic circuits integrated in one or more chips of semiconductor material), or with a combination of software and hardware suitably programmed or otherwise configured.

1. A bookbinding machine for processing book blocks, wherein the bookbinding machine comprises one or more clamps for transporting the book blocks individually in the bookbinding machine, a loading station for loading each current one of the book blocks into each current one of the clamps being therein and a feeding device for feeding the book blocks in succession to the loading station, wherein the feeding device comprises:
an inclined support, extending below the loading station along an inclined direction with respect to a vertical direction in condition of use, for supporting the current book block in a staging position wherein the current book block rests with a main side being a front or a rear thereof on the inclined support, and
a raising system for raising the current book block from the staging position to a loading position, wherein the current book block is inserted into the current clamp being opened in the loading station, comprising moving the current book block transversally to a longitudinal axis of a spine thereof from the staging position to a vertical position wherein the current book block extends with the front and the rear along the vertical direction.

2. The bookbinding machine according to claim 1, wherein the bookbinding machine is configured to stop the current clamp in the loading station for loading the current book block, and wherein the raising system is configured for raising the current book block from the staging position to the vertical position by moving transversally to the longitudinal axis of the spine along the inclined direction and for raising the current book block from the vertical position to the loading position by moving transversally to the longitudinal axis of the spine along the vertical direction.

3. The bookbinding machine according to claim 2, wherein the feeding device comprises:
a vertical support for supporting the current book block during said raising the current book block from the vertical position to the loading position, the vertical support being aligned with a stopping position in the loading station of a fixed jaw of the current clamp.

4. The bookbinding machine according to claim 3, wherein the feeding device comprises:
a feeding support for supporting the current book block on a concave side thereof comprising an inclined segment defining the inclined support, a vertical segment defining the vertical support and a rounded segment linking the inclined segment and the vertical segment.

5. The bookbinding machine according to 4 claim 1, wherein the raising system comprises one or more raising pushers for pushing the current book block from the staging position to the loading position.

6. The bookbinding machine according to claim 5, wherein the raising pushers comprise a first raising pusher for pushing the current book block from the staging position to the vertical position and a second raising pusher for pushing the current book block from the vertical position to the loading position.

7. The bookbinding machine according to claim 6, wherein the first raising pusher comprises a driving element movable along the inclined direction and an active element being driven by the driving element for acting on the spine of the current book block, the active element being pivotable around the driving element for acting on the spine of the current book block along the inclined direction in correspondence to said moving the current book block from the staging position towards the vertical position and progressively from the inclined direction to the vertical direction in correspondence to the vertical position of the current book block

8. The bookbinding machine according to claim 7, wherein the second raising pusher comprises a biasing element for biasing the active element progressively from the inclined direction to the vertical direction in correspondence to the vertical position of the current book block.

9. The bookbinding machine according to claim 6, wherein the bookbinding machine comprises:
an input unit for setting the feeding device to a manual mode wherein one of the raising pushers is maintained at a supporting position below the loading station in condition of use for supporting each of the book blocks being inserted manually from above into the current clamp being opened in the loading station.

10. The bookbinding machine according to claim 1, wherein the feeding device comprises:
a horizontal transport system for transporting the book blocks in succession to the inclined support horizontally in condition of use, the horizontal transport system comprising a horizontal support being aligned with the inclined support for supporting one or more of the book blocks resting with the main side thereon, and one or more horizontal pushers for pushing the book blocks individually along the horizontal support to the inclined support, the current book block in the staging position being aligned with a horizontal reference of the loading station in condition of use by a last one of the horizontal pushers along a transport direction of the horizontal transport system

11. The bookbinding machine according to claim 10, wherein the horizontal pushers (are configured for pushing the book blocks individually through one or more stopping positions along the horizontal support

12. The bookbinding machine according to claim 10, wherein the raising system comprises:
a jogger for jogging the current book block with respect to the horizontal reference during said raising the current book block from the staging position to the loading position.

13. The bookbinding machine according to claim 10, wherein the feeding device comprises:
a lowering transport system for transporting the book blocks in succession to the horizontal transport system downwards in condition of use, wherein the lowering transport system comprises a lowering support extending at least in part downwards in condition of use for supporting one or more of the book blocks resting with the main side thereon and one or more drivers being movable along a transport direction of the lowering transport system for sustaining the spine of the book blocks individually during said transporting the book blocks downwards.

14. The bookbinding machine according to claim 13, wherein the feeding system comprises a sustaining element projecting above the inclined support in condition of use for sustaining the spine of the current book block in the staging position, and a further sustaining element projecting above the horizontal support in condition of use for stopping each of the book blocks at a lower end of the lowering support and for sustaining the book blocks during said transporting the book blocks horizontally, the further sustaining element being aligned with the sustaining element

15-16. (canceled)

17. The bookbinding machine according to claim 2, wherein the raising system comprises a guiding element for guiding the current book block during said raising the current book block from the vertical position to the loading position, and wherein the feeding device comprises a thickness gauge for measuring a thickness of each of the book blocks, and a control unit for setting a width of the guiding element according to the thickness of the current book block.

18. The bookbinding machine according to claim 1, wherein the feeding device comprises a horizontal transport system for transporting the book blocks in succession to the inclined support horizontally in condition of use, the horizontal transport system comprising a horizontal support being aligned with the inclined support for supporting one or more of the book blocks resting with the main side thereon and one or more horizontal pushers for pushing the book blocks individually through one or more stopping positions along the horizontal support, and wherein the feeding device comprises.

19. A thickness gauge for measuring the thickness of each of the book blocks when stopped at one of the stopping positions and a control unit for controlling the bookbinding machine according to the thickness of the book blocks.

20. (canceled)

21. The bookbinding machine according to claim 1, wherein the raising system is configured for raising the current book block from the staging position to a waiting position wherein the current book block extends with the front and the rear along the vertical direction and with a lip thereof in correspondence to a lower end of the current clamp in condition of use and for raising the current book block from the waiting position to the loading position in response to the current clamp being opened in the loading station.

22. The bookbinding machine according to claim 21, wherein the feeding device comprises a width gauge for measuring a width of each of the book blocks and a control unit for setting the waiting position according to the width of the current book block.

23. (canceled)

24. A feeding device for use in a bookbinding machine for processing book blocks, the bookbinding machine comprising one or more clamps for transporting the book blocks individually in the bookbinding machine and a loading station for loading each current one of the book blocks into each current one of the clamps being therein, wherein the feeding device comprises:
an inclined support to be arranged extending below the loading station along an inclined direction with respect to a vertical direction in condition of use, for supporting the current book block in a staging position wherein the current book block rests with a main side being a front or a rear thereof on the inclined support, and
a raising system for raising the current book block from the staging position to a loading position, wherein the current book block is inserted into the current clamp being opened in the loading station, comprising moving the current book block transversally to a longitudinal axis of a spine thereof from the staging position to a vertical position wherein the current book block extends with the front and the rear along the vertical direction.

25. (canceled)

26. A method for processing book blocks in a bookbinding machine, wherein the method comprises:
transporting the book blocks individually in the bookbinding machine by one or more clamps
loading each current one of the book blocks into each current one of the clamps being in a loading station, and
feeding the book blocks in succession to the loading station wherein said feeding the book blocks comprises:
supporting the current book block, by an inclined support extending below the loading station along an inclined direction with respect to a vertical direction, in a staging position wherein the current book block rests with a main side being a or a rear thereof on the inclined support, and
raising the current book block from the staging position to a loading position, wherein the current book block is inserted into the current clamp being opened in the loading station, comprising moving the current book block transversally to a longitudinal axis of a spine thereof from the staging position to a vertical position wherein the current book block extends with the front and the rear along the vertical direction.

27.-28. (canceled)
